(19) United States
(12) Patent Application Publication
(10) Pub. No.: US 2025/0171881 A1
(43) Pub. Date: May 29, 2025

(54) MINERAL WOOL SPINNERS

(71) Applicant: KNAUF INSULATION SPRL, Visé (BE)

(72) Inventors: James MOFFAT, Wrexham (GB); Howard STONE, Cambridge (GB); Paul JACKSON, Southport (GB)

(21) Appl. No.: 18/843,838

(22) PCT Filed: Mar. 10, 2023
(86) PCT No.: PCT/EP2023/056133

§ 371 Date: Sep. 4, 2024

(30) Foreign Application Priority Data
Mar. 11, 2022 (GB) 2203395.5

(51) Int. Cl. C22C 19/07; C03B 37/04

(52) U.S. Cl. CPC C22C 19/07; C03B 37/047

(57) ABSTRACT

A mineral wool spinner comprises a cobalt-chromium alloy or nickel-chromium alloy spinner alloy comprising:

$$Cr \geq 20 wt \% and \leq 40 wt \% :$$

$$C \geq 0.4 wt \% and \leq 1.8 wt \%$$

$$Si \geq 1. wt \%$$

This invention relates to manufacture of mineral wool insulation, particularly to spinners used for fiberizing a mineral melt for producing mineral wool and more particularly to alloys which are suitable for such spinners.

Mineral wool fibres are commonly produced using a rotating spinner having a multitude of orifices in a peripheral wall. A mineral wool melt is introduced into the spinner whose rotation forces the melt against the inner side of the peripheral wall and through the orifices to form primary fibres; these primary fibres are entrained and attenuated in a gas stream to form the desired mineral fibres and then collected to form mineral wool. The harsh conditions to which the spinner is subjected, including high temperatures and exposure to corrosive conditions, the mechanical properties that such spinners must provide in such conditions, the desire to ensure a long service life for such spinners, and the availability and the constraints implicit in the use of suitable materials has made the selection of the materials from which such spinners are made an important aspect of mineral wool manufacturing technology.

In accordance with one of its aspects, the present invention provides a mineral wool spinner as defined in claim 1; other aspects are defined in other independent claims. The dependent claims define preferred and/or alternative embodiments.

One aspect of the present invention is based on the realisation that improvements can be provided to mineral wool spinner alloys by taking advantage of strengthening of the alloy matrix by carbide phases, particularly carbides which form a continuous skeletal network running throughout the alloy microstructure, and that further improvements can be provided by limiting degradation to the carbide phases, notably by reducing or retarding oxidation of the carbides, particularly at critical positions within the alloy matrix. It has been known for some time that oxidation and the effects of oxidation are a major factor limiting the high-temperature service life of cobalt-chromium spinner alloys and nickel-chromium spinner alloys. However, not all of the factors contributing to this oxidation related degradation have been fully understood. Without wishing to be bound by theory, it is presently believed that: i) during high temperature usage, fissures are created by preferential oxidation of the skeletal carbide network in cobalt-chromium and nickel-chromium spinner alloys containing particular amounts of chromium and carbon; ii) these fissures contain regions of low oxygen partial pressure where gaseous chromium species evolve; and iii) resulting volatilisation leads to enhanced wastage of chromium in the local microstructure surrounding the fissures. For example, depletion of chromium from the matrix near the surface of the alloy is thought to inhibit repassivation of the alloy surface, a crucial requirement for long duration high-temperature service. One aim of the present invention is to provide cobalt-chromium and nickel-chromium spinner alloys, based on identification of these mechanisms, which enable increased service life for the spinners.

The term “spinner alloy” as used herein means the alloy making up at least the peripheral wall of the spinner which is or will be provided with fiberizing orifices. Preferably, the entire spinner is cast from the spinner alloy; this facilitates manufacture. One of the advantages of the spinner alloys disclosed herein is their ability to be air cast; this avoids costs and complications involved in vacuum casting. Thus, in one aspect, the invention provides a method of casting a spinner blank from any of the alloys disclosed herein, notably casting in air (as opposed to vacuum casting or casting in a protective atmosphere). The invention further provides manufacturing of a spinner from such a cast spinner blank, notably by providing fiberising orifices in a peripheral wall of the spinner blank.

As used herein, the term “cobalt-chromium alloy” means an alloy which comprises cobalt and chromium and in which, when considering all of the elements present in the alloy other than chromium, the element which is present in the greatest % wt is cobalt, notably in which cobalt accounts for at least 18 wt %, notably at least 25 wt %, of the alloy. The invention is particularly applicable to cobalt-chromium alloys in which the element which is present in the greatest % wt is cobalt and the element that is present in the second greatest wt % is chromium, notably in which chromium accounts for at least 25%, notably at least 30 wt %, of the alloy.

As used herein, the term “nickel-chromium alloy” means an alloy which comprises nickel and chromium and in which, when considering all of the elements present in the alloy other than chromium, the element which is present in the greatest % wt is nickel. The invention is particularly applicable to nickel-chromium alloys in which the element which is present in the greatest % wt is nickel and the element that is present in the second greatest wt % is chromium, notably in which:
nickel accounts for at least 25 wt %, notably at least 30 wt %, of the alloy; and
chromium accounts for at least 22%, notably at least 25 wt %, of the alloy.

The alloys are high carbon alloys. As used herein, the term “high carbon alloy” means an alloy comprising at least 0.4 wt % carbon, preferably at least 0.75 wt % carbon and more preferably at least 1.0 wt % carbon. The high carbon content facilities creation of a reinforcing carbide network, particularly a network of reinforcing chromium carbide(s). The alloy preferably comprises no more than 1.8 wt % carbon, more preferably no more than 1.5 wt % carbon. Quantities of carbon higher than approximately 1.5 wt %, notably higher than approximately 1.8 wt %, in these types of alloys would increase the risk of “locking” most or all the Cr entirely with the carbide network and thus leaving insufficient Cr remaining in the alloy matrix to enable the formation of a desirable protective passivation layer of chromium oxide(s) at the surface.

The spinner alloys comprise Si in an amount which is ≥1.0 wt %, preferably ≥1.2 wt %, more preferably ≥1.4 wt % or ≥1.5 wt %, even more preferably ≥1.8 wt %; the spinner alloys may comprise Si in an amount which is ≤8.0 wt %, preferably ≤6.0 wt %. It is surprising not only that the high levels of silicon of the alloys disclosed herein provide good high temperature oxidation resistance but also that this advantage is provided without deleterious side effects. For example, it would have been thought that the increased levels of silicon would be accompanied by notable and inevitable reduction in the alloy liquidus temperature but this has been found not to be the case. It is currently believed that an effect of the high levels of silicon of the alloys disclosed is to limit degradation of carbide phases in the alloys, particularly chromium carbide(s) and that these levels of silicon can thus be used to improve the performance of the alloys disclosed herein. A particularly preferred range of Si in the spinner alloys disclosed herein is an amount which is ≥1.0 wt % (which provides good high temperature oxidation resistance) and ≤2.5 wt %, particularly ≤2.0; the aforementioned upper Si limits are currently believed to reduce the risk of corrosion from the mineral wool melt to which the spinner will be exposed in its conditions of use. Nevertheless, in some circumstances it may be desirable for the spinner alloy to comprise Si in an amount which is ≥2.0 wt %, particularly ≥2.5 wt % or ≥3.0 wt %; the aforementioned levels of Si are currently believed to be particularly advantageous for reducing fissure depths.

It is currently believed that the advantageous effect of the combination of carbon and silicon disclosed herein is applicable to a spinner alloy matrix comprising the amounts of chromium disclosed herein and in which the alloy matrix comprises or consists essentially of i) cobalt and chromium; ii) nickel and chromium; iii) cobalt, nickel and chromium; or iv) nickel, chromium and iron. Thus, each of claims 3 to 13 defines an applicable spinner alloy matrix.

Preferably, the spinner alloy comprises one or more of the elements R selected from the group consisting of Mo (molybdenum), W (tungsten), Ti (titanium), Nb (niobium) Ta (tantalum) and combinations thereof. The presence of one or more of these elements R in the spinner alloys disclosed herein is useful to provoke the formation of one or more metal carbides to strengthen the alloy matrix. Mo and W tend to form MAC carbides; the term R₁ is used herein to denote elements selected from the group consisting of Mo and W and combinations thereof. Ti, Nb and Ta tend to form MC carbides; the term R₂ is used herein to denote elements selected from the group consisting of Ti, Nb, Ta and combinations thereof.

The spinner alloy preferably comprises R≥2.5 wt %, preferably ≥4 wt %; this provides useful strengthening. The spinner alloy preferably comprises R≤13 wt %, preferably ≤10 wt %; this avoids undesirably reducing the amount of Ni in a nickel-chromium alloy or the amount of cobalt in a cobalt chromium alloy.

The spinner alloy may comprise one of the alloys specified in present claim 2 or any of present claims 19 to 41; each of these defines a suitable alloy composition providing a combination of properties which make them particularly suitable as spinner alloys. With respect to these alloy compositions: i) additional elements may be present to facilitate manufacture notably at levels <2 wt %, for example Mn may be present for facilitating casting, notably for influencing fluidity during casting, preferably at a level ≥0.01 wt % and ≤2 wt %, preferably >0.3 wt % and ≤1.2 wt %; ii) any other element not listed in the specified composition is preferably absent from the composition or, if present is present only as and at levels of an impurity, for example impurities levels when considered individually or in combination of B≤0.05 wt %, P≤0.04 wt %, S≤0.015 wt %, N≤0.05 wt % and O≤0.025 wt %. As used herein the terms “consists essentially of” and “consisting essentially of” are intended to limit the scope of a claim to the specified materials and those that do not materially affect the basic and novel characteristic(s) of the claimed invention.

The present invention also provides a method of manufacturing mineral wool insulation comprising fiberising a mineral melt using a spinner as defined herein to produce mineral wool fibres. The mineral wool fibers are preferably bio-soluble; in particular, the mineral wool fibers preferably satisfy the requirements under Note Q of EU Directive 67/548/EEC for exemption from the classification, packaging and labelling provisions of that Directive.

According to one aspect, the method is used to produce mineral wool fibres having a chemical composition comprising:

| | Range | Preferred ranges |
|---|---|---|
| SiO₂ | 55 to 75 wt %;, | ≥60 wt % or ≥62 wt % |
| | | and/or ≤72 wt %, or ≤70 wt %; |
| combination of CaO | 5 to 22 wt % | ≥11 wt % or ≥13 wt % |
| and MgO | | and/or ≤20 wt % |
| combination of Na₂O | 5 to 20 wt % | ≥7 wt % and/or ≤15 wt %, |
| and K₂O | | or ≤12 wt % or ≤10 wt %; |
| Al₂O₃ | 0 to 7 wt %, | ≥1 wt % or ≥2 wt % |
| | | and/or ≤5 wt %; |
| total iron expressed | 0 to 2 wt %, | ≤0.8 wt % or ≤1 wt % |
| as Fe₂O₃ | | |
| alkali/alkaline-earth | >1 | >1 |
| ratio | | |

In the aforementioned mineral wool fibres the ratio of alkali/alkaline-earth, which as is conventional is expressed in terms of wt % of the alkali oxides/alkaline-earth oxides eg (Na₂O+K₂O)/(CaO and MgO), is >1.

The use of the spinner alloy provides a spinner having an improved working life for fiberizing such mineral wool fibres.

According to another aspect, the method is used to produce mineral wool fibres having a chemical composition comprising:

| | Range | Preferred ranges |
|---|---|---|
| SiO₂ | 30 to 55 wt % | 39 to 52 wt % |
| combination of CaO | 8 to 23 wt % | |
| and MgO | | |
| combination of Na₂O | 4 to 24 wt % | |
| and K₂O | | |
| Al₂O₃ | 10 to 30 wt % | 16 to 26 wt % |
| total iron expressed | 4 to 14 wt % | |
| as Fe₂O₃ | | |
| alkali/alkaline-earth | <1 | |
| ratio | | |

The use of the spinner alloy provides a spinner which can be reliably operated at a temperature suitable for fiberizing such mineral wool fibres.

Embodiments of the invention will now be described, by way of example only, along with experimental work upon which the inventions disclosed herein are based, with reference to the accompanying drawing of which:

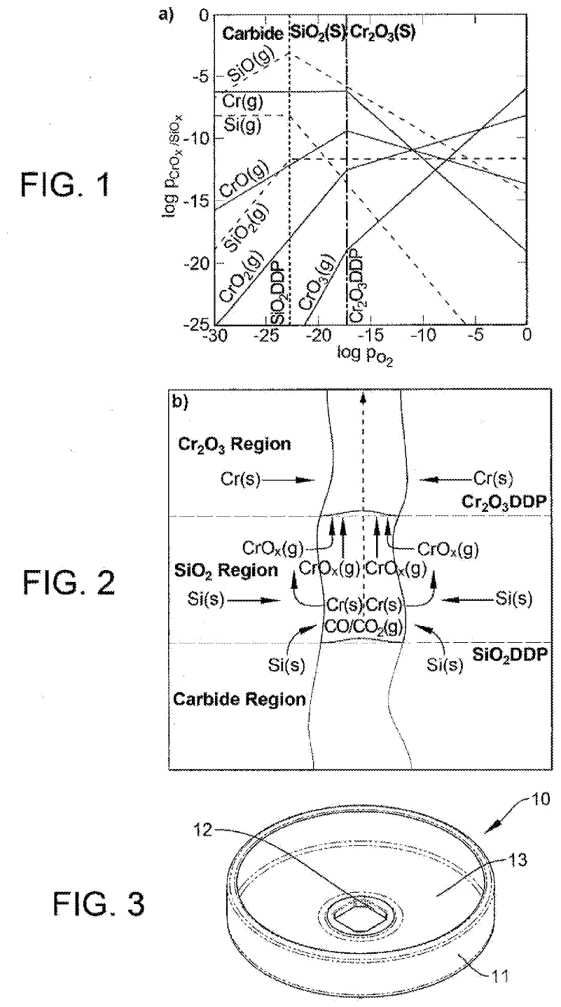

FIG. 1 is a vapour pressure species diagram of the Si-O and Cr-O systems; and

FIG. 2 is a schematic diagram representation of an oxidising interdendritic carbide network (ICN);

FIG. 3 is a schematic perspective view of a mineral wool spinner.

In one of its aspects, the present invention is based on selecting the nominal Alloy B composition of Table 1 (and samples of this having the actual composition shown in Table 2) as a particularly useful starting point for further investigation and development for improved spinner alloys.

It was previously known that the oxidation of the interdendritic carbide network (ICN) of alloys similar to Alloy B leads to the formation of two major oxides within the resulting fissure: Cr₂O₃, and SiO₂. Whilst such oxides have been commonly observed in Co-based superalloy oxidation, the present invention, at least in some of its aspects, is based on: i) further insight into relationships between the depth of the fissure and the oxide(s) that forms at that depth i.e. Cr₂O₃ forms at the tops of the fissure, whereas SiO₂ forms at the tips of the fissure of these types of alloys; and ii) the current belief that the mechanism leading to the formation of depth-specific oxides within the fissures of these types of alloys is dependent on the oxygen partial pressures within the fissure, as shown in FIG. 1. Surface-breaking regions of the interdendritic carbide network (ICN) rapidly oxidise at high temperature, leading to the formation of the analogous oxides of the interdendritic carbide network (ICN) constituent elements. However, as the fissure reaches greater depths into the alloy subsurface, the availability of oxygen decreases. Eventually, past a certain depth, the oxygen partial pressure is below the dissociation partial pressure (DPP) of chromia, and therefore cannot form chromia, as illustrated in FIG. 2. However, below the dissociation partial pressure (DPP) of chromia, Si can form silica, which forms in place of the chromia. This explains a sudden change that has now been discovered between the oxidation product within the fissure.

Whilst the above explains the change in the preferred oxidation product, this mechanism does not address why Cr has been determined to be absent at the tips of the fissures. Considering the vapour pressure species diagram for Cr and Si at high temperatures illustrated in FIG. 1, at low oxygen partial pressure Cr can continue to react to form volatile oxides or species, including Cr gas, CrO, CrO₂, and CrO₃. Since these species are volatile at high temperatures, they rapidly diffuse up the fissure until they meet an oxygen partial pressure that allows them to condense into chromia. This short-circuit diffusion method is now thought to lead to the depletion of Cr from deep within the fissure, explaining the absence of a Cr signal which has been observed within energy dispersive X-ray spectroscopy (EDX) maps at the fissure tips. Furthermore, if Cr from the oxidising interdendritic carbide network (ICN) can be lost via gas transport, it is reasonable to assume Cr loss from the surrounding matrix phase can be accelerated near the fissures as a result of diffusion to the fissure and subsequent volatilsation. Cr loss deep within the alloy could deleteriously impact the oxidation resistance of the alloy, by depleting Cr reserves within the matrix phase used to repassivate the surface of the alloy in the event of scale spallation, cracking, or other forms of damage.

Since low oxygen partial pressure causes the formation of volatile species, which are now thought to deplete the matrix and interdendritic carbide network (ICN) of Cr, minor variations to the composition of the alloy may hinder the formation of the volatile compounds.

In another of its aspects the present invention is based on using the defined alloy compositions, notably the presence of the defined quantities of silicon in these alloy composition, to improve the oxidation resistance of these types of alloys by i) using formation of silica to stabilise the formation of chromia and thus increase the stability of a passivating chromia layer so as to insulate the interdendritic carbide network (ICN) from gaseous oxygen thus slowing the production of volatile species; and/or ii) increasing the concentration of Si in the matrix phase so that more silica forms within the fissures during oxidation, effectively obstructing oxygen from reaching deeper into the fissure and thereby reducing the rate of volatilisation of Cr.

### Experiments

Investigations were carried out by: a) defining the nominal compositions of alloys to be tested, as set out in Table 1 and b) producing samples of these alloys for testing. The approximate bulk compositions of the cast produced alloys, determined by EDX and adjusted to take into account surface contamination of C and O) is shown in Table 2.Alloy B and Alloy 1 are comparative examples.

TABLE 1
nominal compositions of alloys in wt %

| | Co | Cr | Ni | Mo | Fe | C | Mn | Si | Sum |
|---|---|---|---|---|---|---|---|---|---|
| Alloy B | 50.5 | 30.0 | 10.0 | 5.0 | 3.0 | 0.5 | 0.5 | 0.6 | 100 |
| Alloy 1 | 51.4 | 29.8 | 10.0 | 4.9 | 3.0 | 0.5 | 0.5 | 0.0 | 100 |
| Alloy 2 | 49.8 | 30.1 | 10.1 | 5.0 | 3.0 | 0.5 | 0.5 | 1.0 | 100 |
| Alloy 3 | 48.3 | 30.5 | 10.2 | 5.0 | 3.0 | 0.5 | 0.5 | 2.0 | 100 |
| Alloy 4 | 46.7 | 30.8 | 10.3 | 5.1 | 3.1 | 0.5 | 0.5 | 3.1 | 100 |
| Alloy 5 | 45.0 | 31.2 | 10.4 | 5.1 | 3.1 | 0.5 | 0.5 | 4.2 | 100 |

TABLE 2
actual alloy compositions tested in wt %

| wt % | Co | Cr | Ni | Mo | Fe | C | Mn | Si | Sum |
|---|---|---|---|---|---|---|---|---|---|
| Alloy B | 45.5 | 34.1 | 10.9 | 5.2 | 2.5 | 0.5 | 0.6 | 0.8 | 100 |
| Alloy 1 | 48.8 | 32.1 | 9.8 | 5.3 | 3.1 | 0.5 | 0.5 | 0.0 | 100 |
| Alloy 2 | 47.6 | 32.1 | 9.9 | 5.3 | 3.1 | 0.5 | 0.5 | 1.0 | 100 |
| Alloy 3 | 46.1 | 32.5 | 9.9 | 5.4 | 3.2 | 0.5 | 0.5 | 2.0 | 100 |
| Alloy 4 | 44.6 | 32.7 | 10.2 | 5.3 | 3.2 | 0.5 | 0.5 | 3.0 | 100 |
| Alloy 5 | 42.9 | 33.2 | 10.3 | 5.3 | 3.2 | 0.5 | 0.5 | 4.1 | 100 |

The EDX-determined bulk compositions of Alloys 1-5 shown in Table 2 are consistent with the nominal compositions. However, higher concentrations of Cr were present within the specimens, with trace contaminating quantities of Al also present and likely originating from the casting procedure.

### Results and Discussion

The microstructures of the as-cast Alloys 1-5 were examined using BSE SEM micrographs (i.e. back-scattered electron, scanning electron microscope images). All microstructures possessed dendrites with a highly connected carbide network within the interdendritic regions, which comprised two constituents, one bright and one dark BSE contrast. The dark BSE contrast interdendritic constituent was indicative of a low atomic mass element such as Cr, whereas the brighter BSE contrast constituent was suggestive of a high atomic mass such as Mo. With increasing Si content, the bright BSE contrast phase became the favoured interdendritic constituent. The interdendritic phases in Alloy 5 became significantly coarser compared to the lower Si-containing alloys during casting, with the interdendritic constituent possessing a fine lamella type morphology. This suggests formation of a different constituent of the interdendritic region in Alloy 5 during casting.

Cuboidal specimens were cut from arc melted ingots of Alloys 1-5 and were oxidised at 1100° C. for 100 hours in a box furnace. Spalled oxides were captured by containing the oxidation process within loose lidded alumina crucibles. The mass gain is shown in Table 3:

TABLE 3
mass gain after oxidation at 1100° C. for 100 hours

| Sample tested | Mass gain (mg/cm²) |
|---|---|
| Alloy 1 | 1.46 |
| Alloy B | 2.97 |
| Alloy 2 | 0.04 |
| Alloy 3 | 0.03 |
| Alloy 4 | 0.05 |
| Alloy 5 | 0.03 |

Alloy 1 had undergone complete oxidation after exposure, whereas Alloys 2-5 showed evidence of oxidation and spallation. Spalled oxides were found to be dark green indicative of chromia, whereas Alloy 1 appear to be a dark blue-green, possibly due to the higher quantities of Co oxide being present. The surfaces of Alloys 4 and 5 exhibited a yellow colour in addition to the green chromia, which may be indicative of an additional oxidation product. The mass gain increased between Alloy 1 and the Alloy B, before decreasing sharply in Alloys 2-5. Catastrophic oxidation was observed for Alloy 1.

Although Alloy B showed a larger mass gain than Alloy 1, catastrophic oxidation was not observed in Alloy B, only a thickening of the chromia scale. This suggests that a substantial quantity of Alloy 1 had volatilised, leading to a lower mass gain compared to Alloy B. The oxidation of the interdendritic carbide network (ICN) may have continued to produce large quantities of volatile Cr species within the fissures. With no silica formation at the tips of the fissures, the production of volatile Cr-containing species was not tempered. Therefore, the continued volatilisation could have induced catastrophic loss to the alloy's integrity, leading to complete oxidation.

These results show the influence Si has on the oxidation properties: the increased quantity of Si of Alloys 2-5 compared to that of Alloy B leads to a significant decrease in mass gains during high-temperature oxidation.

The surface cross-sections of Alloys 2-5 following oxidation for 100 hours at 1100° C. were analysed using BSE images and Co, Ni, Fe, Mo, O, Cr, and Si quantitative EDX maps. No cross-section of Alloy 1 could be obtained after oxidation. The high temperature of the oxidation led to morphological changes in the interdendritic phases. In Alloy 2, the interdendritic phase became coarser and appeared to show a higher areal fraction of bright BSE contrast constituent, which suggests a transformation of the Cr-rich constituent into the Mo-rich constituent. Alloy 3 on the other hand did not show an increase in the bright BSE contrast phase. It appeared the interdendritic region had undergone a significant transformation from a skeletal morphology to a spheriodised Cr-rich and Mo-depleted phase. This suggests that significant interdiffusion of Mo into the matrix phase had occurred in this alloy. Alloy 4 also showed evidence of spheroidisation and coarsening of the interdendritic phases; the interdendritic phase had become enriched with Si compared to the as-cast state, although both Mo and Cr were still present. Alloy 5 exhibited a substantial morphological change compared to the as-cast state. The interlamellar structure had spheroidised and was no longer rich with Cr. The phase remained rich in Mo as well as Si, suggesting that interdiffusion during high-temperature exposure may have induced a phase transformation.

The surface oxides for the alloys were indicative of a chromia surface layer with a Ni-rich overscale in Alloys 2, 3, and 5. Alloy 4 possessed a near-continuous silica layer at the metal-oxide interface and a compact Co-Ni-Fe-rich overscale, indicative of a spinel. Surface-breaking regions of the interdendritic phases were found to be preferentially oxidised leaving behind fissures. These fissures penetrated into the alloy subsurface to different depths, as shown in Table 4. Alloys 2 and 3 exhibited similar attack depths into the subsurface which were similar to those of Alloy B. However, reduced fissure depths were observed in Alloys 4 and 5.

TABLE 4
fissure attack depth during 1100° C. oxidation after 100 hours

| | | |
|---|---|---|
| | Average fissure depth | Standard deviation of |
| Sample tested | (μm) | depth |

| | |
|---|---|
| Alloy 1 | Fissure depth not obtained - |
| | complete oxidation |

| | | |
|---|---|---|
| Alloy 2 | 71.9 | 4.4 |
| Alloy 3 | 71.7 | 9.1 |
| Alloy 4 | 33.6 | 6.2 |
| Alloy 5 | 41.2 | 6.2 |

The reduced attack depth in Alloys 4 and 5 indicate several possibilities, including a more protective oxide, reduced volatilisation of the interdendritic phases, and/or the interdendritic phases were more resistant to oxidation. The oxidation products within the fissures were predominantly silica, with only sparing examples of chromia forming in the upper regions of the fissures in Alloys 3 and 5. This suggests that the formation of the silica layer in the early stages of oxidation was significant enough to form a near-continuous layer. This in turn provided a basis for the chromia scale to rapidly form on top, further protecting the alloy from internal oxidation. An apparent anomaly concerning this behaviour was Alloy 4; no chromia scale was detected in this alloy, and instead, a dense continuous

Co-Ni-Fe scale formed on top of the silica layer. The fissures that formed in this alloy still contained silica. This could be due to the higher Si content within the interdendritic phase, rather than bulk Si diffusion through the matrix phase; this could perhaps be determined by further investigation of the microstructural behaviour of Alloy 4

It thus appears that:
the presence of Si in Alloy B and similar alloys is critical for the oxidation properties at temperatures of 1100° C.;
absence of Si from these type of alloys leads to catastrophic oxidation of the alloy, due to volatilisation of Cr;
increased amounts of Si leads to the formation of increasing amounts of silica within the oxidising interdendritic regions. Si content of at least about 1.0 wt % assists formation of a near-continuous silica layer at the surface of the alloy, greatly assisting the formation of a chromia overscale. This reduces the mass gains of this type of alloy.
it appears that attack depths of the interdendritic network were particularly reduced with Alloy 4.

The concepts upon which the inventions disclosed herein are based are believed to apply not only to the particular cobalt-chromium alloys upon which the experimental work focussed but more generally to alloys having similar carbide networks, and particularly to alloys having chromium-based carbide networks, in combination with amounts of silicon for which the mechanisms disclosed herein will also apply. Such similar carbide networks are present, for example, in cobalt-chromium alloys and nickel-chromium alloys.

The mineral wool spinner 10 illustrated schematically in FIG. 3 comprises a peripheral wall 11 provided with spinner orifices (not shown), a drive portion 12 via which the spinner 10 is rotated about a vertical axis and a connecting flange 13 joining the peripheral wall 11 to the drive 12. In use, a mineral melt is introduced into the spinner 10 between the drive 4 and the peripheral wall; rotation of the spinner 2 forces the melt through the orifices in the peripheral wall from where individual streams of the melt are attenuated into mineral fibres by an attenuating gas flow.

The attenuated fibres are subsequently collected and used to form mineral wool insulation product.

### REFERENCE NUMBERS

10 spinner
11 peripheral wall
12 drive portion
13 connecting flange

1.-43. (canceled)

44. A mineral wool spinner, wherein the spinner alloy consists essentially of:

| | wt % |
|---|---|
| Co | ≥37 and ≤55 |
| Ni | ≥9 and ≤12 |
| Cr | ≥31 and ≤34 |
| C | ≥0.4 and ≤1.2 |
| Si | ≥1 and ≤4 |
| Fe | ≤3 |
| Mo + W | ≥4 and ≤7 |

45. A mineral wool spinner, wherein the spinner alloy comprises:

| | wt % |
|---|---|
| Co | ≥37 and ≤55 |
| Ni | ≥9 and ≤12 |
| Cr | ≥31 and ≤34 |
| C | ≥0.4 and ≤1.2 |
| Si | ≥1 and ≤4 |
| Fe | ≤3 |
| Mo + W | ≥4 and ≤7 |

46. A mineral wool spinner, in which the mineral wool spinner is a cobalt-chromium alloy and in which
the element which is present in the greatest % wt in the cobalt-chromium alloy is cobalt, the element that is present in the second greatest wt % in the cobalt-chromium alloy is chromium, and the element which is present in the third greatest wt % in the cobalt-chromium alloy is nickel,
and in which the cobalt-chromium alloy comprises the following elements present in the following % weights:
$$Cr \geq 20 wt \% and \leq 40 wt \% :$$
$$Ni \geq 5 wt \%$$
$$C \geq 0.4 wt \% and \leq 1.8 wt \%$$
$$Si \geq 1. wt \%$$

47. The mineral wool spinner of claim 46, in which the cobalt-chromium alloy comprises the following elements present in the following % weights

| | |
|---|---|
| Ni | ≥8 wt % |

48. The mineral wool spinner of claim 46, in which the cobalt-chromium alloy comprises the following elements present in the following % weights
$$C \geq 0.4 wt \% and \leq 1.5 wt \% .$$

49. The mineral wool spinner of claim 46, in which the cobalt-chromium alloy comprises the following elements present in the following % weights

| | |
|---|---|
| Si | ≥1.2 wt %. |

50. The mineral wool spinner of claim 46, in which the cobalt-chromium alloy comprises the following elements present in the following % weights
$$Si \geq 1.2 wt \% and \leq 2.5 wt \% .$$

51. The mineral wool spinner of claim 46, in which the cobalt-chromium alloy comprises the following elements present in the following % weights

| | |
|---|---|
| Si | ≥1.5 wt %. |

52. The mineral wool spinner of claim 46, in which the cobalt-chromium alloy comprises the following elements present in the following % weights
$$Si \geq 2.5 wt \% and \leq 6. wt \% .$$

53. The mineral wool spinner of claim 46, in which the cobalt-chromium alloy comprises the following elements present in the following % weights
$$R \geq 2.5 wt \% and \leq 13 wt \%$$
where R represents Mo, W, Ti, Nb, Ta and combinations thereof.

54. The mineral wool spinner of claim 46, in which the cobalt-chromium alloy comprises the following elements present in the following % weights
$$R \geq 4 wt \% and \leq 10 wt \%$$
where R represents Mo, W, Ti, Nb, Ta and combinations thereof.

55. The mineral wool spinner of claim 46, in which the cobalt-chromium alloy comprises the following elements present in the following % weights
$$Si \geq 1.5 wt \% ,$$
$$R \geq 2.5 wt \% and \leq 13 wt \%$$
where R represents Mo, W, Ti, Nb, Ta and combinations thereof.

56. The mineral wool spinner of claim 46, in which the cobalt-chromium alloy comprises the following elements present in the following % weights
$$Si \geq 1.5 wt \% ,$$
$$R \geq 4 wt \% and \leq 10 wt \%$$
where R represents Mo, W, Ti, Nb, Ta and combinations thereof.
